(19) United States
(12) Patent Application Publication
(10) Pub. No.: US 2022/0329080 A1
(43) Pub. Date: Oct. 13, 2022

(54) ENERGY STORAGE APPARATUS AND METHOD OF SUPPRESSING DETERIORATION OF ENERGY STORAGE DEVICE

(71) Applicant: GS Yuasa International Ltd., Kyoto-shi, Kyoto (JP)

(72) Inventors: Tetsuhiro KOBAYASHI, Kyoto (JP); Tetsuya MURAI, Kyoto (JP)

(21) Appl. No.: 17/634,165

(22) PCT Filed: Jun. 18, 2020
(86) PCT No.: PCT/JP2020/023892

§ 371 Date: Feb. 9, 2022

(30) Foreign Application Priority Data
Aug. 20, 2019 (JP) 2019-150377

(51) Int. Cl. H02J 7/00; H02J 7/02; H01M 10/0525; H01M 10/48; H01M 10/44; H01M 10/46; H01M 50/583; H01M 50/209; H01M 10/42; B60L 58/10; B60L 53/62

(52) U.S. Cl. CPC H02J 7/0016; H02J 7/0029; H02J 7/0047; H02J 7/02; H01M 10/0525; H01M 10/48; H01M 10/44; H01M 10/46; H01M 50/583; H01M 50/209; H01M 10/425; B60L 58/10; B60L 53/62; H02J 9/061

(57) ABSTRACT

Disclosed is an energy storage apparatus 2 including a battery cell 16 in which a positive electrode P and a negative electrode N are immersed in a nonaqueous electrolyte solution 18 in a state of being partitioned by a separator 20 and a BMU 46, in which the BMU 46 executes detection processing of detecting a state in which a voltage of the battery cell 16 does not substantially change, and discharge processing of discharging the battery cell 16 in response to detection of the state in the detection processing.

### TECHNICAL FIELD

The present invention relates to an energy storage apparatus and a method of suppressing deterioration of an energy storage device.

### BACKGROUND ART

It is known that an energy storage device such as a lithium ion secondary battery deteriorates when repeatedly charged and discharged. Deterioration means an increase in direct current resistance (DCR) and a decrease in charge capacity (in other words, capacity retention ratio). For this reason, deterioration of the energy storage device has been conventionally suppressed (see, for example, Patent Document 1 and Patent Document 2).

Specifically, Patent Document 1 discloses that lithium is aggregated to be whiskers on a surface of graphite that is a negative electrode during charge. When the lithium whiskers are partly separated, the separated lithium is attached to a separator partitioning a positive electrode and a negative electrode, and an energy storage device may be deteriorated due to clogging of the separator. Patent Document 1 discloses that reverse pulse current is supplied in a battery for a short time during charge to perform temporary discharge multiple times, in other words, to apply a reverse pulse group, whereby a lithium whisker is dissolved.

Patent Document 2 discloses that when a battery such as a lithium ion secondary battery is charged or discharged, a reaction product (also referred to as “dross”) is formed and deposited on an electrode surface. The deposited reaction product increases in size with the lapse of time, and causes severe deterioration of the battery. Patent Document 2 discloses that a charge current and an inversion pulse current are alternately supplied during charge, or a discharge current and the inversion pulse current are alternately supplied during discharge, whereby an electrode is electrically stimulated, and the reaction product formed during charge or during discharge is prevented from being deposited, or the formed reaction product is dissolved.

### PRIOR ART DOCUMENTS

### Patent Documents

Patent Document 1: JP-A-2014-170741

Patent Document 2: JP-A-2014-187002

### SUMMARY OF THE INVENTION

### Problems to be Solved by the Invention

The technique described in Patent Document 1 and the technique described in Patent Document 2 described above suppress deterioration of the energy storage device during charge and discharge. During charge and discharge, a voltage of the energy storage device substantially changes. Thus, the technique described in Patent Document 1 and the technique described in Patent Document 2 suppress deterioration of the energy storage device when the voltage of the energy storage device substantially changes.

The present specification discloses a technique for suppressing deterioration of the energy storage device when the voltage of the energy storage device does not substantially change.

### Means for Solving the Problems

Disclosed is an energy storage apparatus including: an energy storage device in which a positive electrode and a negative electrode are immersed in a nonaqueous electrolyte solution in a state of being partitioned by a separator; and a management unit, in which the management unit executes detection processing of detecting a state in which a voltage of the energy storage device does not substantially change, and discharge processing of discharging the energy storage device in response to detection of the state in the detection processing.

### Advantages of the Invention

It is possible to suppress deterioration of the energy storage device when the voltage of the energy storage device does not substantially change.

### BRIEF DESCRIPTION OF THE DRAWINGS

FIG. 1 is a schematic diagram of an uninterruptible power supply including an energy storage apparatus according to Embodiment 1.

FIG. 2 is a schematic view showing an overall configuration of the energy storage apparatus.

FIG. 3 is a perspective view of a battery cell (for convenience, a case is shown in a transparent state).

FIG. 4 is a side view of an electrode assembly as viewed from an X direction shown in FIG. 3.

FIG. 5 is a schematic view showing an electrical configuration of the energy storage apparatus.

FIG. 6A is a view showing an experimental result of a capacity retention ratio.

FIG. 6B is a graph showing the experimental result of the capacity retention ratio.

FIG. 7A is a view showing an experimental result of a DCR change rate (ambient temperature: 25° C.).

FIG. 7B is a graph showing the experimental result of the DCR change rate (ambient temperature: 25° C.).

FIG. 8A is a view showing an experimental result of the DCR change rate (ambient temperature: −10° C.).

FIG. 8B is a graph showing the experimental result of the DCR change rate (ambient temperature: −10° C.).

FIG. 9A is a view showing an experimental result of the capacity retention ratio.

FIG. 9B is a graph showing the experimental result of the capacity retention ratio.

FIG. 10A is a view showing an experimental result of the DCR change rate (ambient temperature: 25° C.).

FIG. 10B is a graph showing the experimental result of the DCR change rate (ambient temperature: 25° C.).

FIG. 11A is a view showing an experimental result of the DCR change rate (ambient temperature: −10° C.).

FIG. 11B is a graph showing the experimental result of the DCR change rate (ambient temperature: −10° C.).

FIG. 12 is a schematic view for explaining a mechanism for producing a polymer near an electrode.

FIG. 13 is a view showing an experimental result of the DCR change rate (ambient temperature: −10° C.).

### MODE FOR CARRYING OUT THE INVENTION

### Outline of Present Embodiment

(1) An energy storage apparatus including: an energy storage device in which a positive electrode and a negative electrode are immersed in a nonaqueous electrolyte solution in a state of being partitioned by a separator; and a management unit, in which the management unit executes detection processing of detecting a state in which a voltage of the energy storage device does not substantially change, and discharge processing of discharging the energy storage device in response to detection of the state in the detection processing.

The “state in which the voltage of the energy storage device does not substantially change” typically includes a state in which the energy storage device is not charged by a charger and discharge from the energy storage device to an electric load is not performed. In addition, the concept of the “state in which the voltage of the energy storage device does not substantially change” disclosed herein may include an aspect in which the energy storage device is charged by the charger at a minute current value at which the voltage of the energy storage device does not substantially change, or discharge from the energy storage device to the electric load is performed. Therefore, for example, a state in which constant voltage charge such as a constant current and constant voltage charge method or a float charge method is performed on the energy storage device at a minute current value at which the voltage of the energy storage device does not substantially change (for example, in the case of the constant current and constant voltage method, a state in which constant voltage charge is performed at a current value of 1/10 or less of the value at the time of constant current flowing) and a state in which discharge from the energy storage device to the electric load is performed in order to supply dark current are typical examples of the “state in which the voltage of the energy storage device does not substantially change” referred to herein.

When the voltage of the energy storage device does not substantially change, a change amount of the voltage per unit time of the energy storage device is small. For this reason, the “state in which the voltage of the energy storage device does not substantially change” may be a “state in which the change amount of the voltage per unit time of the energy storage device is equal to or less than a predetermined value”.

When the voltage of the energy storage device does not substantially change, a change amount of a state of charge (SOC) per unit time of the energy storage device is small. For this reason, the “state in which the voltage of the energy storage device does not substantially change” may be a “state in which the change amount of the state of charge per unit time of the energy storage device is equal to or less than a predetermined value”.

The expression that “discharging the energy storage device in response to detection of the state in the detection processing” includes not only a case where the discharge processing is executed when the state is detected, but also a case where the discharge processing is executed when another condition is further satisfied in addition to the case where the state is detected.

When the energy storage device in which the positive electrode and the negative electrode are immersed in the nonaqueous electrolyte solution in a state in which the positive electrode and the negative electrode are partitioned by the separator is left in a high temperature state or a high voltage state, a polymer derived from the nonaqueous electrolyte solution is easily generated near the electrode. The term “being left” means that a state in which the voltage of the energy storage device does not substantially change continues for a long period of time.

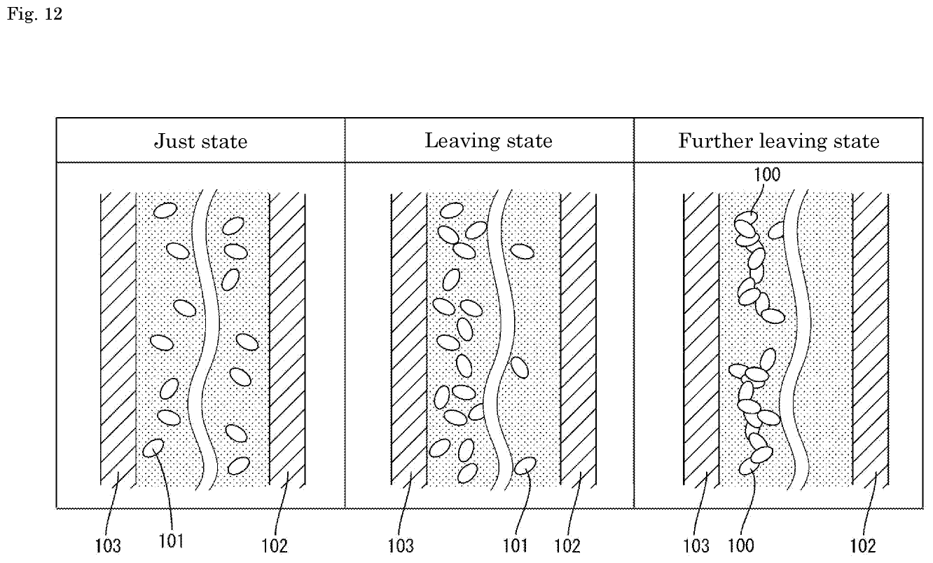

With reference to FIG. 12, a mechanism for producing the polymer near the electrode will be described. A “just state”, a “leaving state”, and a “further leaving state” shown in FIG. 12 represent the same region of the same electrode (positive electrode 103 and negative electrode 102).

The “just state” indicates a state immediately after the energy storage device is charged and brought into a state in which the voltage is high, in other words, a state of charge (SOC) is high. A monomer 101 capable of constituting a polymer 100 is dispersed in the nonaqueous electrolyte solution. The “leaving state” indicates a state in which the energy storage device is left in a state in which the voltage does not substantially change from the “just state”. When the energy storage device is left at a high voltage, electrophoresis occurs, and a concentration gradient occurs in the monomer 101. Thus, in the “leaving state”, the concentration of the monomer 101 on the negative electrode 102 side decreases, and the concentration of the monomer 101 near the positive electrode 103 increases. The “further leaving state” indicates a state in which the energy storage device is left in a state in which the voltage does not substantially change from the “leaving state”. Since the energy storage device is left in a state in which the concentration of the monomer 101 near the positive electrode 103 is high, an atmosphere in which a continuous reaction easily proceeds is obtained, and the polymer 100 is generated.

The inventor of the present application has paid attention to this point, and has found that when the energy storage device is left (particularly left in the high voltage state), the polymer 100 generated during leaving closes a pore of the separator to cause clogging, and the energy storage device may be deteriorated due to unevenness of a current density.

According to the energy storage apparatus described above, the discharge processing of discharging the energy storage device is executed in response to the detection of the state in which the voltage of the energy storage device does not substantially change. With such a configuration, it is possible to suppress deterioration of the energy storage device when the voltage of the energy storage device does not substantially change. Although it is not necessary to clarify the reason why such an effect can be obtained, for example, the following reason is presumed.

When a discharge current is applied to the energy storage device in the “leaving state” shown in FIG. 12, molecules gathered near the positive electrode 103 are diffused to eliminate the concentration gradient. Thus, it is presumed that this is because the state changes from the “leaving state” to the “just state”, an atmosphere in which a polymerization reaction tends to proceed is eliminated.

Thus, according to the energy storage apparatus, even if the energy storage device is left in the high temperature state or the high voltage state, it is possible to suppress deterioration of the energy storage device.

In FIG. 12, although the aspect in which the concentration of the monomer 101 near the positive electrode 103 increases has been described, even in an aspect in which the concentration of the monomer 101 near the negative electrode 102 increases, the effect of the present invention can be obtained.

A compound that can act as the monomer 101 in the mechanism described above is an organic compound in which charges are unevenly distributed. That is, as long as the organic compound contains an element having high electronegativity such as nitrogen, oxygen, or a halogen element in the molecule and has an asymmetric molecular structure, the effect of the present invention can be obtained. Examples of such a compound include cyclic carbonates, chain carbonates, carboxylic acid esters, phosphoric acid esters, sulfonic acid esters, ethers, amides, and nitriles.

(2) The state may be a non-use state in which the energy storage apparatus is not used.

In the non-use state in which the energy storage apparatus is not used, the voltage of the energy storage device does not substantially change. Thus, it can be said that the non-use state is the state in which the voltage of the energy storage device does not substantially change.

(3) The energy storage device may be a lithium ion battery in which the positive electrode contains a ternary active material.

Types of the lithium ion battery include a lithium ion battery in which an iron-based active material (such as lithium iron phosphate) is contained in a positive electrode, a lithium ion battery in which a ternary active material (nickel, manganese, cobalt) is contained in a positive electrode, and other lithium ion batteries. In the following description, the lithium ion battery in which the iron-based active material is contained in the positive electrode is simply referred to as an iron-based lithium ion battery, and the lithium ion battery in which the ternary active material is contained in the positive electrode is simply referred to as a ternary lithium ion battery. The ternary lithium ion battery can be charged to a higher voltage than the iron-based lithium ion battery. Thus, in the ternary lithium ion battery, the polymer 100 is easily generated as compared with the iron-based lithium ion battery.

According to the energy storage apparatus, since the discharge processing is executed in response to the detection of the state in which the voltage of the energy storage device does not substantially change, it is possible to suppress deterioration of the energy storage device when the voltage of the energy storage device does not substantially change. Thus, it is particularly useful in the case of the ternary lithium ion battery that can be charged to a high voltage (in other words, a lithium ion battery in which the polymer 100 is easily generated).

(4) In the discharge processing, the management unit may intermittently discharge the energy storage device, or may discharge the energy storage device while alternately changing an intensity of a current.

As a method of discharging the energy storage device, a method of discharging the energy storage device at a constant current only once can be considered. However, there is a possibility that the atmosphere in which the polymerization reaction tends to proceed is not sufficiently eliminated only by discharging the energy storage device at a constant current only once. According to the energy storage apparatus, the energy storage device is intermittently discharged in the discharge processing, or the energy storage device is discharged while the intensity of the current is alternately changed, so that the atmosphere in which the polymerization reaction tends to proceed can be more reliably eliminated as compared with the case where the energy storage device is discharged at a constant current only once.

(5) The management unit may cause a charger to charge the energy storage device after discharging the energy storage device in the discharge processing.

Since the voltage decreases when the energy storage device is discharged, there is a possibility that the energy storage device is not sufficiently charged when the energy storage device is used. According to the energy storage apparatus, since the energy storage device is charged after the energy storage device is discharged, an amount of electricity discharged can be charged. Thus, it is possible to reduce the possibility that the energy storage device is not sufficiently charged when the energy storage device is used.

(6) The management unit may discharge the energy storage device by a circuit other than a main circuit to which the energy storage device is connected in the discharge processing.

The state in which the voltage of the energy storage device does not substantially change is a state in which electric power is not supplied from the energy storage device to an external electric load due to, for example, interruption of the main circuit to which the energy storage device is connected. Thus, the energy storage device cannot be discharged by the external electric load. According to the energy storage apparatus described above, since the energy storage device is discharged by the circuit other than the main circuit, the energy storage device can be discharged even in the state in which electric power is not supplied from the energy storage device to the external electric load.

(7) The energy storage apparatus includes a circuit breaker connected in series with the energy storage device, and in the discharge processing, the management unit may cause a current for opening the circuit breaker or a current for closing the circuit breaker to flow from the energy storage device to the circuit breaker to discharge the energy storage device.

According to the energy storage apparatus, since the energy storage device is discharged by the circuit breaker, the energy storage device can be discharged without newly adding hardware for discharging the energy storage device.

(8) The energy storage apparatus include: a plurality of the energy storage devices; and an equalization circuit that has a discharge resistor and equalizes a voltage of each of the energy storage devices by discharging the energy storage device, having a relatively high voltage among the plurality of energy storage devices, with the discharge resistor, in which the management unit may cause the equalization circuit to discharge the energy storage device in the discharge processing.

In general, the energy storage apparatus includes an equalization circuit. According to the energy storage apparatus, since the energy storage device is discharged by the equalization circuit in the discharge processing, the configuration of the energy storage device can be simplified as compared with the case where a discharge circuit is provided separately from the equalization circuit.

(9) The energy storage apparatus include: a plurality of the energy storage devices; an equalization circuit that has a first discharge resistor and equalizes a voltage of each of the energy storage devices by discharging the energy storage device, having a relatively high voltage among the plurality of energy storage devices, with the first discharge resistor; and a discharge circuit that has a second discharge resistor, in which the management unit may cause the discharge circuit to discharge the energy storage device in the discharge processing.

In general, the energy storage apparatus includes an equalization circuit. When the energy storage device is discharged, it is also conceivable to discharge the energy storage device by the equalization circuit. However, in general, in the equalization circuit, the current that can flow is small due to restrictions such as manufacturing cost and size. For this reason, when the equalization circuit is used, a large current cannot flow, and an effect of suppressing deterioration of the energy storage device may be small. When the discharge resistor of the equalization circuit is increased, a large current can flow; however, when the discharge resistor is increased, there is a disadvantage that it is difficult to finely adjust the voltage at the time of equalization.

According to the energy storage apparatus, since the discharge circuit is provided separately from the equalization circuit, as compared with the case where the discharge resistor of the equalization circuit is increased, it is possible to increase the effect of suppressing deterioration of the energy storage device while facilitating fine adjustment of the voltage at the time of equalization.

When the discharge circuit is provided separately from the equalization circuit, there is also an advantage that an effect can be obtained only by adding a simple circuit to the existing equalization circuit as compared with a case where the size of the equalization circuit is increased.

(10) The management unit may execute the discharge processing when the state in which the voltage of the energy storage device does not substantially change continues for a predetermined time or longer.

When the time during which the state in which the voltage of the energy storage device does not substantially change continues is short, the energy storage device hardly deteriorates. According to the energy storage apparatus, the energy storage device is not discharged when the time during which the state in which the voltage of the energy storage device does not substantially change continues is less than the predetermined time, so that discharge with a small effect can be suppressed.

(11) The management unit may execute the discharge processing when the state in which the voltage of the energy storage device does not substantially change is detected by the detection processing and when the voltage or the charge state of the energy storage device is a predetermined value or more.

When the voltage is low (in other words, when SOC is low), it is difficult to generate the polymer 100. According to the energy storage apparatus, the energy storage device is not discharged when the voltage or SOC of the energy storage device is less than a predetermined value, so that discharge with a small effect can be suppressed.

(12) The energy storage apparatus may be used in an uninterruptible power supply.

As described above, the technique described in Patent Document 1 and the technique described in Patent Document 2 suppress deterioration of the energy storage device during charge and discharge. During charge and discharge, a voltage of the energy storage device substantially changes. Thus, it can be said that the technique described in Patent Document 1 and the technique described in Patent Document 2 are based on the attribute that the energy storage device deteriorates when the voltage of the energy storage device substantially changes.

On the other hand, the inventor of the present application has found an unknown attribute that the energy storage device may deteriorate even when the voltage of the energy storage device does not substantially change. The energy storage apparatus utilizes this unknown attribute discovered by the inventor of the present application. Since an uninterruptible power supply is not used during non-power failure, a period during which the voltage of the energy storage device does not substantially change is long. For this reason, there is a concern that the energy storage device deteriorates during non-power failure, and original performance cannot be exhibited during power failure. When the energy storage apparatus is used for an uninterruptible power supply, deterioration of the energy storage device can be suppressed during non-power failure, so that there is a high possibility that original performance can be exhibited during power failure.

(13) The energy storage apparatus may be mounted on a vehicle.

The energy storage apparatus for replacement of the energy storage apparatus mounted on a vehicle may be stored as inventory for a long period of time at a store (such as an automobile dealer or an auto parts store) after being manufactured. The voltage of the energy storage device does not substantially change during storage. For this reason, there is a concern that the energy storage device deteriorates during storage, and the energy storage device cannot exhibit the original performance when mounted on the vehicle.

The energy storage apparatus utilizes the unknown attribute described above. When the energy storage apparatus is used for the energy storage apparatus mounted on the vehicle, deterioration of the energy storage device can be suppressed during storage, so that there is a high possibility that the original performance can be exhibited when the energy storage apparatus is mounted on the vehicle.

(14) The energy storage apparatus may be used in an energy storage system.

The energy storage system (ESS) is a system that stores electric power for a peak shift in which electric power generated at night is used in the daytime, a peak cut in which electric power exceeding contract electric power is supplied from the energy storage system when large electric power is temporarily required, and the like. The energy storage system may be left until a power system is operated. For example, the energy storage device installed at an initial stage of construction of the energy storage system may be left for several months or more. The voltage of the energy storage device does not substantially change during leaving. For this reason, there is a concern that the energy storage device deteriorates during leaving, and the energy storage device cannot exhibit the original performance when the power system is operated.

The energy storage apparatus utilizes the unknown attribute described above. When the energy storage apparatus is used for the energy storage system, deterioration of the energy storage device can be suppressed during leaving, so that there is a high possibility that the original performance can be exhibited when the power system is operated.

(15) A method of suppressing deterioration of an energy storage device in which a positive electrode and a negative electrode are immersed in a nonaqueous electrolyte solution in a state of being partitioned by a separator, the method including a detection step of detecting a state in which a voltage of the energy storage device does not substantially change; and a discharge step of discharging the energy storage device in response to detection of the state in the detection step.

According to the deterioration suppressing method, the discharge processing of discharging the energy storage device is executed in response to the detection of the state in which the voltage of the energy storage device does not substantially change. With such a configuration, it is possible to suppress deterioration of the energy storage device when the voltage of the energy storage device does not substantially change.

The invention disclosed in the present specification can be implemented in various modes such as an apparatus, a method, a computer program for implementing a function of the apparatus or the method, and a recording medium recording the computer program.

### Embodiment 1

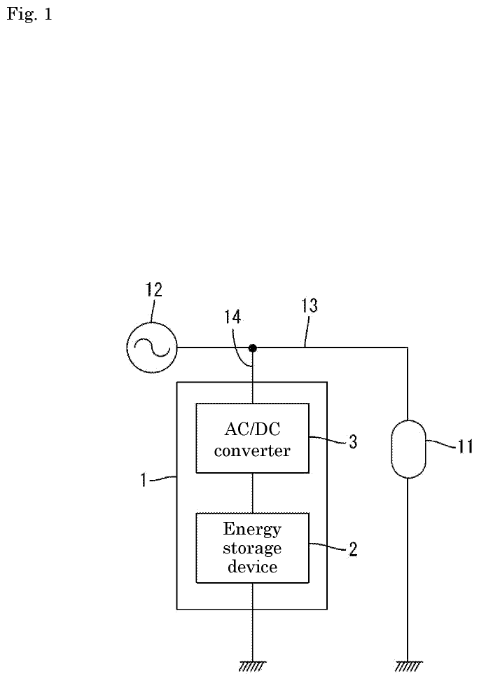

Embodiment 1 will be described with reference to FIGS. 1 to 11. In the following description, reference numerals of the drawings may be omitted for the same components except for a part thereof.

An uninterruptible power supply (UPS) 1 including an energy storage apparatus 2 according to Embodiment 1 will be described with reference to FIG. 1. The UPS 1 is a device that stores electric power supplied from a commercial power source 12 and supplies electric power to an electric load 11 when electric power from the commercial power source 12 is cut off due to a power failure or the like. As shown in FIG. 1, the UPS 1 is connected to a power line 14 branching from a power line 13 connecting the commercial power source 12 and the electric load 11.

The UPS 1 includes an AC/DC converter 3 that converts an AC voltage supplied from the commercial power source 12 into a DC voltage, and the energy storage apparatus 2. The energy storage apparatus 2 is float charged (floating charge) by electric power supplied from the commercial power source 12. The floating charge is a charge method of constantly maintaining the energy storage apparatus 2 in a fully charged state by continuously applying a constant voltage.

(1) Configuration of Energy Storage Apparatus

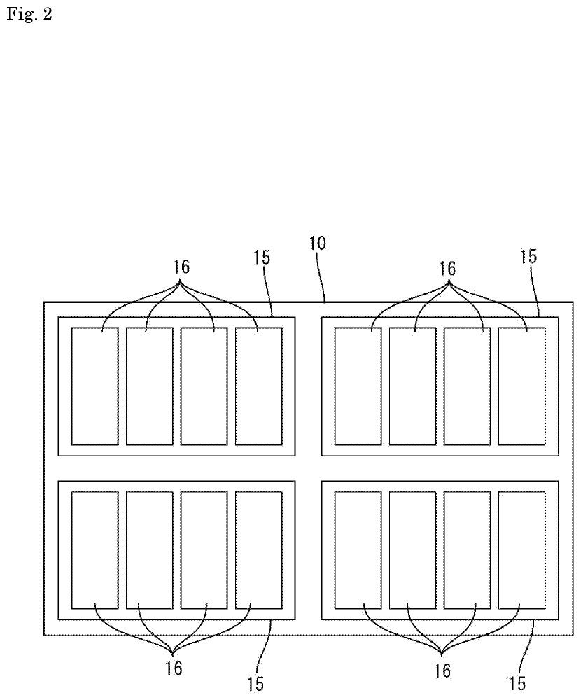

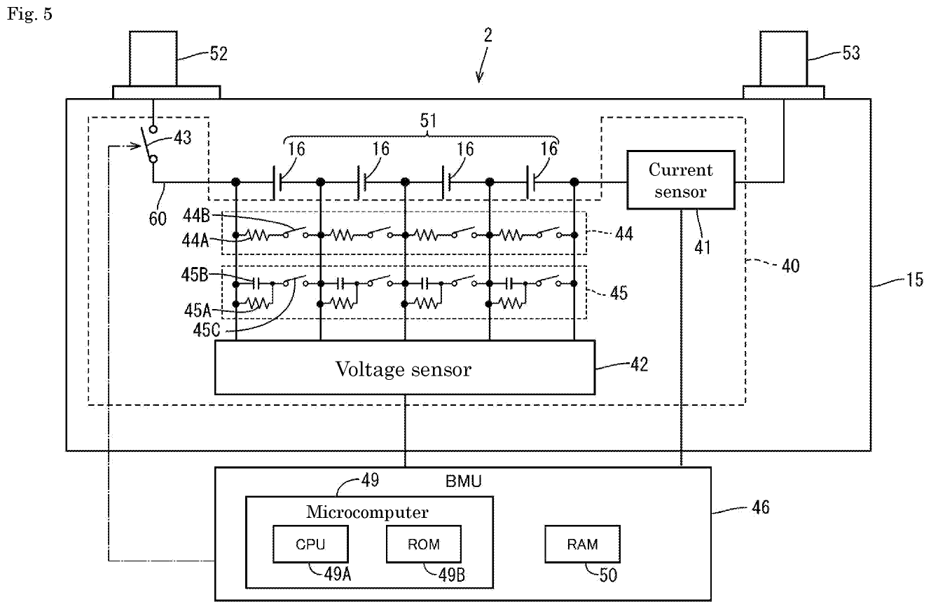

An overall configuration of the energy storage apparatus 2 will be described with reference to FIG. 2. The energy storage apparatus 2 includes a plurality of (four in FIG. 2) energy storage units 15 and a BMU 46 (see FIG. 5) to be described later. Each of the energy storage units 15 includes a plurality of (four in FIG. 2) battery cells 16. The energy storage apparatus 2 may include a busbar (not shown) for electrically connecting the plurality of battery cells 16 and a busbar (not shown) for electrically connecting the plurality of energy storage units 15.

(2) Configuration of Battery Cell

The battery cell 16 is a nonaqueous electrolyte secondary battery which is an example of a nonaqueous electrolyte energy storage device, and is specifically a ternary lithium ion battery.

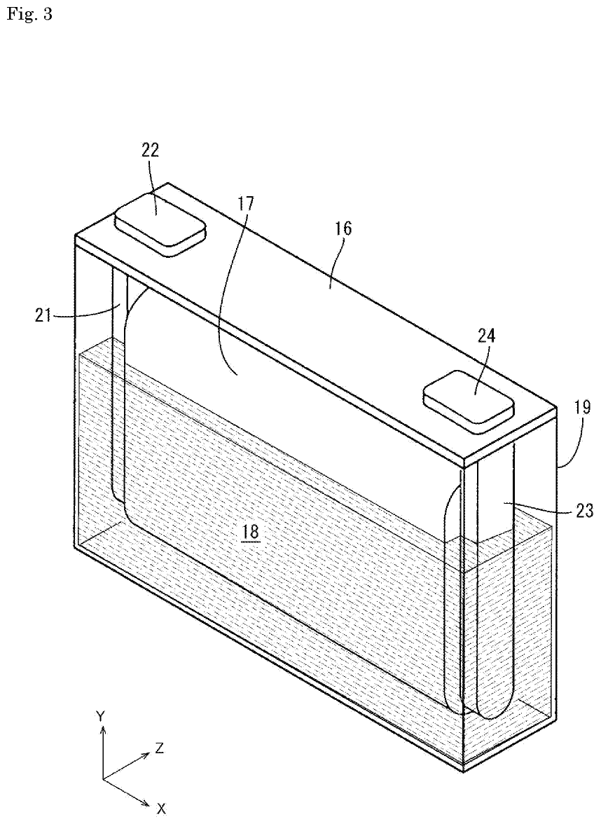

As shown in FIG. 3, the battery cell 16 according to Embodiment 1 is a prismatic battery, and includes an electrode assembly 17, a nonaqueous electrolyte solution 18, and a case 19 in which these are accommodated. The electrode assembly 17 is accommodated in the case 19 in a state of being immersed in the nonaqueous electrolyte solution 18.

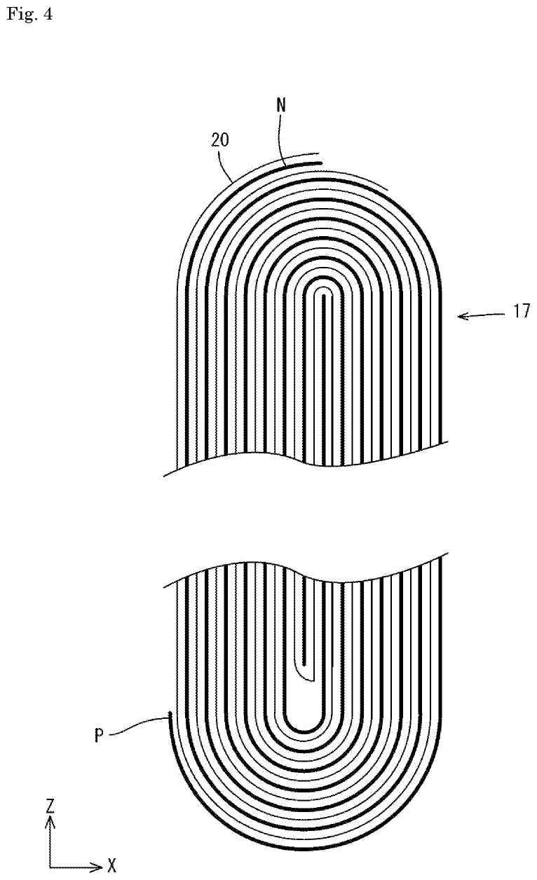

As shown in FIG. 4, in the electrode assembly 17, a positive electrode P and a negative electrode N formed in a sheet shape are wound in a flat shape while shifting the position in a Y direction (direction perpendicular to a paper surface in FIG. 4) with a separator 20 sandwiched between the electrodes. The electrode assembly 17 shown in FIG. 4 is a longitudinally wound electrode assembly whose winding axis extends in a horizontal direction. As shown in FIG. 3, the positive electrode P is electrically connected to a positive electrode terminal 22 via a positive electrode lead 21. The negative electrode N is electrically connected to a negative electrode terminal 24 via a negative electrode lead 23.

The electrode assembly 17 may be of a horizontal winding type whose winding axis extends in a vertical direction, or may be of a stack type in which a sheet-like positive electrode P and a sheet-like negative electrode N are stacked with the separator 20 interposed the electrodes. The battery cell 16 is not limited to the prismatic battery, and may be a cylindrical battery, a laminated film battery, a flat battery, a coin battery, a button battery, or the like.

(2-1) Positive Electrode

The positive electrode P has a positive electrode substrate having conductivity, and a positive active material layer disposed on the positive electrode substrate directly or via an intermediate layer. The configuration of the intermediate layer is not particularly limited.

As the material of the positive electrode substrate, a metal such as aluminum, titanium, tantalum, stainless steel, or an alloy thereof is used. Among these, aluminum or an aluminum alloy is preferable from the viewpoint of electric potential resistance, high conductivity, and costs. Examples of the positive electrode substrate include a foil and a deposited film, and a foil is preferable in terms of costs. Therefore, the positive electrode substrate is preferably an aluminum foil or an aluminum alloy foil. Examples of the aluminum or aluminum alloy include A1085P, A3003, and the like specified in JIS-H-4000 (2014).

The positive active material layer contains a positive active material. The positive active material layer contains optional components such as a conductive agent, a binder (binding agent), a thickener, a filler, or the like as necessary.

The positive active material can be appropriately selected from known positive active materials. As the positive active material for a lithium ion secondary battery, a material capable of absorbing and releasing lithium ions is usually used. Examples of the positive active material include a lithium transition metal composite oxide having an α-NaFeO₂-type crystal structure, a lithium transition metal oxide having a spinel-type crystal structure, a polyanion compound, a chalcogenide, and sulfur. Examples of the lithium transition metal composite oxide having an α-NaFeO₂ type crystal structure include Li[LiₓNi₁₋ₓ]O₂ (0≤x<0.5), Li[LiₓNi_{γ}Co_{(1-x-γ)}]O₂ (0≤x<0.5, 0<γ<1), Li[LiₓCo₍₁₋ₓ₎]O₂ (0≤x<0.5), Li[LiₓNi_{γ}Mn_{(1-x-γ)}]O₂ (0≤x<0.5, 0<γ<1), Li[LiₓNi_{γ}Mn_{β}Co_{(1-x-γ-β}]O₂ (0≤x<0.5, 0<γ, 0<β, 0.5<γ+β<1) (ternary system), and Li[LiₓNi_{γ}Co₆Al_{(1-x-γ-β)}]O₂ (0≤x<0.5, 0<γ, 0<β, 0.5<γ+β<1). Examples of the lithium transition metal oxide having a spinel-type crystal structure include LiₓMn₂O₄ and LiₓNi_{γ}Mn_{(2-γ)}O₄. Examples of the polyanion compound include LiFePO₄ (iron base), LiMnPO₄, LiNiPO₄, LiCoPO₄, Li₃V₂(PO₄)₃, Li₂MnSiO₄, and Li₂CoPO₄F. Examples of the chalcogenide include titanium disulfide, molybdenum disulfide, and molybdenum dioxide. Atoms or polyanions in these materials may be partially substituted by atoms or anion species composed of other elements. These materials may have surfaces coated with other materials.

Among these materials, a ternary positive active material is preferably used. In the ternary lithium ion battery that can be charged to a high voltage, the energy storage device tends to deteriorate when the voltage of the energy storage device does not substantially change. Thus, it is possible to sufficiently enjoy the effect of the present invention for solving the problem.

In the positive active material layer, one of these materials may be used singly, or two or more of these materials may be mixed and used.

(2-2) Negative Electrode

The negative electrode N has a negative electrode substrate having conductivity, and a negative active material layer disposed on the negative electrode substrate directly or via an intermediate layer. The configuration of the intermediate layer is not particularly limited.

As the material of the negative electrode substrate, a metal such as copper, nickel, stainless steel, a nickel-plated steel, or aluminum, or an alloy thereof is used. Among them, copper or a copper alloy is preferable. Examples of the negative electrode substrate include a foil and a deposited film, and a foil is preferable in terms of costs. Therefore, the negative electrode substrate is preferably a copper foil or a copper alloy foil. Examples of the copper foil include rolled copper foil and electrolytic copper foil.

The negative active material layer contains a negative active material. The negative active material layer contains optional components such as a conductive agent, a binder (binding agent), a thickener, a filler, or the like as necessary.

The negative active material layer may contain a typical nonmetal element such as B, N, P, F, Cl, Br, or I, a typical metal element such as Li, Na, Mg, Al, K, Ca, Zn, Ga, or Ge, or a transition metal element such as Sc, Ti, V, Cr, Mn, Fe, Co, Ni, Cu, Mo, Zr, Ta, Hf, Nb, Sn, Sr, Ba, and W as components other than the negative active material, the conductive agent, the binder, the thickener, and the filler.

The negative active material can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as an Si oxide, a Ti oxide, and an Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, graphite and non-graphitic carbon are preferable. In the negative active material layer, one of these materials may be used singly, or two or more of these materials may be mixed and used.

(2-3) Separator

The separator 20 can be appropriately selected from known separators. As the separator 20, for example, a separator composed of only a substrate layer, a separator in which a heat resistant layer containing heat resistant particles and a binder is formed on one surface or both surfaces of the substrate layer, or the like can be used. Examples of a material of the substrate layer of the separator 20 include a woven fabric, a nonwoven fabric, and a porous resin film. Among these materials, a porous resin film is preferable from the viewpoint of strength, and a nonwoven fabric is preferable from the viewpoint of liquid retention property of the nonaqueous electrolyte solution 18. As the material of the substrate layer of the separator 20, a polyolefin such as polyethylene or polypropylene is preferable from the viewpoint of a shutdown function, and polyimide, aramid or the like is preferable from the viewpoint of resistance to oxidation and decomposition. As the substrate layer of the separator 20, a material obtained by combining these resins may be used.

A porosity of the separator 20 is preferably 80 vol % or less from the viewpoint of strength, and is preferably 20 vol % or more from the viewpoint of discharge performance. Here, the “porosity” is a volume-based value, and means a value measured with a mercury porosimeter.

(2-4) Nonaqueous Electrolyte Solution

The nonaqueous electrolyte solution 18 can be appropriately selected from known nonaqueous electrolyte solutions 18. The nonaqueous electrolyte solution 18 contains a nonaqueous solvent and an electrolyte solution salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among them, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among them, EMC is preferable.

As the nonaqueous solvent, it is preferable to use the cyclic carbonate or the chain carbonate, and it is more preferable to use the cyclic carbonate and the chain carbonate in combination. By using the cyclic carbonate, dissociation of the electrolyte solution salt can be promoted to improve ionic conductivity of the nonaqueous electrolyte solution 18. By using the chain carbonate, viscosity of the nonaqueous electrolyte solution 18 can be suppressed to be low. When the cyclic carbonate and the chain carbonate are used in combination, a volume ratio of the cyclic carbonate to the chain carbonate (cyclic carbonate:chain carbonate) is preferably in a range from 5:95 to 50:50, for example.

The electrolyte solution salt can be appropriately selected from known nonaqueous electrolyte solution salts. Examples of the electrolyte solution salt include a lithium salt, a sodium salt, a potassium salt, a magnesium salt, and an onium salt. Among these, a lithium salt is preferable.

Examples of the lithium salt include inorganic lithium salts such as LiPF₆, LiPO₂F₂, LiBF₄, LiClO₄, and LiN(SO₂F)₂, and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F), LiC(SO₂CF₃)₃ and LiC(SO₂C₂F₅)₃. Among these, an inorganic lithium salt is preferable, and LiPF₆ is more preferable.

The content of the electrolyte solution salt in the nonaqueous electrolyte solution 18 is preferably 0.1 M or more and 2.5 M or less, more preferably 0.3 M or more and 2.0 M or less, still more preferably 0.5 M or more and 1.7 M or less, and particularly preferably 0.7 M or more and 1.5 M or less. When the content of the electrolyte solution salt is within the above range, the ionic conductivity of the nonaqueous electrolyte solution 18 can be increased.

The nonaqueous electrolyte solution 18 may contain an additive. Examples of the additive include halogenated carbonic acid esters such as fluoroethylene carbonate (FEC) and difluoroethylene carbonate (DFEC); oxalic acid esters such as lithium bis(oxalate)borate (LiBOB), lithium difluorooxalatoborate (LidFOB), and lithium bis(oxalate)difluorophosphate (LiFOP); imide salt such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, propane sultone, propene sultone, butane sultone, methyl methanesulfonate, busulfan, methyl toluenesulfonate, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, perfluorooctane, tristrimethylsilyl borate, tristrimethylsilyl phosphate, tetrakistrimethylsilyl titanate, lithium monofluorophosphate, and lithium difluorophosphate. These additives may be used singly, or two or more may be mixed and used.

The content of the additive contained in the nonaqueous electrolyte solution 18 is preferably 0.01% by mass or more and 10% by mass or less, more preferably 0.1% by mass or more and 7% by mass or less, still more preferably 0.2% by mass or more and 5% by mass or less, and particularly preferably 0.3% by mass or more and 3% by mass or less, with respect to a total mass of the nonaqueous electrolyte solution 18. When the content of the additive is within the above range, it is possible to improve capacity retention performance or cycle performance after high-temperature storage, and to further improve safety.

(3) Electrical Configuration of Energy Storage Apparatus

An electrical configuration of the energy storage apparatus 2 will be described with reference to FIG. 5. As described above, the energy storage apparatus 2 includes the plurality of energy storage units 15 (only one energy storage unit 15 is shown in FIG. 5) and the BMU 46 (Battery Management Unit) that manages the plurality of energy storage units 15.

The energy storage unit 15 includes a positive electrode external terminal 52, a negative electrode external terminal 53, the four battery cells 16 connected in series with a main circuit 60 connecting the positive electrode external terminal 52 and the negative electrode external terminal 53, and a CMU 40 (Cell Management Unit). In the following description, the four battery cells 16 are referred to as an assembled battery 51.

The CMU 40 includes a current sensor 41, a voltage sensor 42, a circuit breaker 43, an equalization circuit 44, and a discharge circuit 45.

The current sensor 41 is connected in series with the assembled battery 51. The current sensor 41 measures a charge-discharge current of the assembled battery 51 and outputs the measured charge-discharge current to the BMU 46.

The voltage sensor 42 is connected in parallel with each of the battery cells 16. The voltage sensor 42 measures a terminal voltage of each of the battery cells 16 and a voltage across the assembled battery 51, and outputs the measured voltages to the BMU 46.

The circuit breaker 43 is connected in series with the assembled battery 51. The circuit breaker 43 is a relay, a field effect transistor (FET), or the like. The circuit breaker 43 is turned on/off (opened/closed) by the BMU 46.

The equalization circuit 44 is a circuit for equalizing the voltage of each of the battery cells 16. The equalization circuit 44 includes a discharge resistor 44A connected in parallel with each of the battery cells 16, and a switch 44B connected in series with each of the discharge resistors 44A. The switch 44B is a relay, an FET, or the like, and is turned on/off by the BMU 46.

The discharge circuit 45 is a circuit used when the battery cell 16 is discharged by deterioration suppression processing described later. The discharge circuit 45 includes a discharge resistor 45A connected in parallel with each of the battery cells 16, a capacitor 45B connected in parallel with the discharge resistor 45A, and a switch 45C connected in series with the discharge resistor 45A and the capacitor 45B.

A resistance value of the discharge resistor 45A is larger than a resistance value of the discharge resistor 44A of the equalization circuit 44. The switch 45C is a relay, an FET, or the like, and is turned on/off by the BMU 46. When the switch 45C is turned on, a voltage is generated across the capacitor 45B. As a result, the capacitor 45B is charged, and a charge current to the capacitor 45B is discharged from the battery cell 16. When the charge of the capacitor 45B is completed, the discharge from the battery cell 16 also disappears. When the switch 45C is turned off, the capacitor 45B is discharged by the discharge resistor 45A connected to both ends of the capacitor 45B, and the voltage between both ends becomes 0. Thus, when the switch 45C is turned on next time, the capacitor 45B can be charged again. The discharge circuit 45 is an example of a circuit other than the main circuit 60 to which the battery cell 16 is connected.

The BMU 46 includes a microcomputer 49 in which a CPU 49A, a RAM 49B, and the like are integrated into one chip, a ROM 50, and the like. The ROM 50 stores various kinds of software and data. The BMU 46 manages the energy storage unit 15 by executing the software stored in the ROM 50. The CMU 40 and the BMU 46 are examples of the management unit.

(4) Processing Executed by BMU

SOC estimation processing, protection processing, equalization processing, and the deterioration suppression processing among the processings executed by the BMU 46 will be described.

The SOC estimation processing is processing of estimating the SOC of the energy storage unit 15. As a method of estimating the SOC, for example, a current integration method is known. The current integration method is a method in which the current value of the current flowing through the assembled battery 51 is measured at predetermined time intervals by the current sensor 41, and the SOC is estimated by adding or subtracting the measured current value to or from an initial capacity. The method of estimating the SOC is not limited to the current integration method. For example, since there is a relatively accurate correlation between an open circuit voltage (OCV) of the energy storage unit 15 and the SOC, the SOC may be estimated from the OCV.

The protection processing is processing of protecting the battery cell 16 from overcharge, overdischarge, overcurrent, and the like. Specifically, the protection processing includes processing of opening the circuit breaker 43 to protect the battery cell 16 from overcharge or overdischarge when the SOC increases to a predetermined upper limit value or more or decreases to a predetermined lower limit value or less, processing of opening the circuit breaker 43 to protect the battery cell 16 from overcurrent when the current sensor 41 detects a current value equal to or more than the predetermined upper limit value, and other processing.

The equalization processing is processing of discharging the battery cell 16 having a relatively high voltage by the equalization circuit 44 such that a difference between the voltage of the battery cell 16 having the highest voltage and the voltage of the battery cell 16 having the lowest voltage among the four battery cells 16 constituting one energy storage unit 15 is equal to or less than a predetermined reference value.

The deterioration suppression processing is processing of suppressing deterioration of the battery cell 16 by discharging the battery cell 16 in response to detection of a state in which the voltage of the battery cell 16 does not substantially change. In the deterioration suppression processing according to Embodiment 1, the battery cell 16 is discharged using the discharge circuit 45. Thus, in the deterioration suppression processing according to Embodiment 1, the equalization circuit 44 is not used for discharging the battery cell 16.

The deterioration suppression processing includes detection processing and discharge processing. In the detection processing, the BMU 46 measures the discharge current of the battery cell 16 at predetermined time intervals by the current sensor 41, and when a value of the discharge current changes from a predetermined reference value (for example, 0.001 C) or more to less than the predetermined reference value, it is determined that a state in which the voltage of the battery cell 16 does not substantially change is detected.

Since the UPS 1 enters a standby state (non-use state) in which electric power is not supplied to the electric load 11 during non-power failure, the voltage of the battery cell 16 does not substantially change. Thus, in the case of the UPS 1, when the UPS 1 is in the non-use state, the state is detected as the state in which the voltage of the battery cell 16 does not substantially change.

When the BMU 46 detects the above-described state in the detection processing, the BMU 46 starts the discharge processing. In the discharge processing, the BMU 46 discharges the battery cell 16 by turning on/off the switch 45C of the discharge resistor 45A according to the conditions shown in Table 1 below.

TABLE 1

| Discharge period | | | | | | |
|---|---|---|---|---|---|---|
| Discharge pulse 1 | | Discharge pulse 2 | | | | |
| (main pulse) | | (weak pulse) | | Pulse | Discharge | |
| Magnitude | Discharge | Magnitude | Discharge | discharge | pause | Charge |
| [CmA] | [time] [msec] | [CmA] | [time] [msec] | time [min] | time [min] | period |
| X 1 | Y 1 | X 2 | Y 2 | Y 3 | Y 4 | Z |

Specifically, in the discharge processing, a discharge period for discharging the battery cell 16 and a charge period for charging the battery cell 16 are alternately repeated. The time of the discharge period (=Y3+Y4) and the time of the charge period (=Z) are the same. The time of the discharge period and the time of the charge period are not necessarily the same.

The unit of the magnitude of a discharge pulse is CmA (milliampere). CmA is a unit representing the magnitude of the charge-discharge current of the energy storage device, and is generally referred to as a C rate. The C rate is obtained by defining, as 1C, the magnitude of a current flowing when the energy storage device having an SOC of 100% is discharged to 0% in one hour (or the magnitude of the current flowing when the energy storage device having an SOC of 0% is charged to 100% in one hour). For example, when the energy storage device is discharged from the SOC of 100% to 0% in 30 minutes, the C rate is 2C. When the charge capacity of the battery cell 16 is different, the current value of the charge-discharge current is different even if the C rate is the same.

Under the conditions shown in Table 1, the discharge pulse is discharged for the first Y3 hours (pulse discharge time) in the discharge period, and the discharge is paused for the subsequent Y4 hours (discharge pause time). In the discharge for the first Y3 hours, the current is continuously caused to flow constantly while alternately changing the intensity of the current. Specifically, flowing of a discharge pulse 1 (main pulse) only for Y1 hours at a discharge rate X1CmA and flowing of a discharge pulse 2 (weak pulse) only for Y2 hours at a discharge rate X2CmA are alternately repeated for Y3 hours.

The discharge pulse may be discharged only once during the pulse discharge time. Specifically, when the discharge time (Y1 hours) of the discharge pulse 1 is equal to the pulse discharge time (Y3 hours), the discharge pulse 1 is discharged only once during the pulse discharge time.

In the discharge for Y3 hours, the current may be intermittently discharged. Specifically, the discharge pulse 1 (main pulse) may be discharged for Y1 hours at the discharge rate X1CmA, and then discharge may be stopped for Y2 hours.

The upper limit value of the discharge time of the discharge pulse is preferably 1 second, more preferably 750 milliseconds, and still more preferably 520 milliseconds. With such a configuration, even when a period during which the voltage of the energy storage device does not substantially change is extended for a long period, it is possible to surely obtain the effect of the present invention.

The lower limit of the discharge time of the discharge pulse is not particularly limited, and may be the shortest time that can be realized by electric control. The lower limit value of the discharge time of the discharge pulse may be, for example, 0.1 milliseconds, 0.3 milliseconds or more, or 0.5 milliseconds.

The discharge time of the discharge pulse may be, for example, 0.1 milliseconds or more and less than 1 second, 0.3 milliseconds or more and less than 750 milliseconds, or 0.5 milliseconds or more and less than 520 milliseconds.

The lower limit value of the magnitude of the discharge pulse is preferably 0.1 CmA. Accordingly, the effect of the present invention can be reliably exhibited. The lower limit value of the magnitude of the discharge pulse may be 0.1 CmA, 0.5 CmA, or 1 CmA.

The upper limit value of the magnitude of the discharge pulse is preferably 10 CmA, preferably 5 CmA, and more preferably 3 CmA. As a result, a discharge pulse circuit can be downsized.

The magnitude of the discharge pulse may be 0.1 CmA or more and 10 CmA or less, 0.5 CmA or more and 5 CmA or less, or 1 CmA or more and 3 CmA or less.

The charge current can be appropriately set according to the environment and conditions to be used. As a preferable example, the upper limit value of the magnitude of the charge current during the charge period is preferably 0.4 CmA, more preferably 0.2 CmA, and still more preferably 0.1 CmA. This makes it possible to suppress lithium electrodeposition associated with charge.

The lower limit value of the magnitude of the charge current during the charge period is not particularly limited, and may be the shortest time that can be realized by the electric control. The lower limit value of the charge current during the charge period may be, for example, 0.01 CmA, 0.02 CmA, or 0.03 CmA.

The magnitude of the charge current during the charge period may be 0.01 CmA or more and 0.4 CmA or less, 0.02 CmA or more and 0.2 CmA or less, or 0.03 CmA or more and 0.1 CmA or less.

When power supply from the battery cell 16 to the external electric load 11 is started, the BMU 46 ends the discharge processing. Specifically, when electric power is supplied from the battery cell 16 to the external electric load 11, the current value of the discharge current of the battery cell 16 increases. Thus, when the discharge current larger than a preset current value is measured, the BMU 46 determines that the voltage of the battery cell 16 substantially changes and ends the discharge processing. The BMU 46 may end the discharge processing by determining that the voltage of the battery cell 16 substantially changes when a change amount of the voltage per unit time of the battery cell 16 becomes larger than a predetermined value.

According to the energy storage apparatus 2, in the discharge processing, the battery cell 16 is discharged while the intensity of the discharge current is alternately changed, so that the atmosphere in which the polymerization reaction tends to proceed can be more reliably eliminated as compared with a case where the battery cell 16 is discharged only once.

According to the energy storage apparatus 2, since the battery cell 16 is discharged by the circuit (discharge circuit 45) other than the main circuit 60 to which the battery cell 16 is connected, the battery cell 16 can be discharged even in a state in which electric power is not supplied from the battery cell 16 to the external electric load 11.

According to the energy storage apparatus 2, since the discharge circuit 45 is provided separately from the equalization circuit 44, as compared with the case where the discharge resistor 44A of the equalization circuit 44 is increased, it is possible to increase the effect of suppressing deterioration of the battery cell 16 while facilitating fine adjustment of the voltage at the time of equalization. When the discharge circuit 45 is provided separately from the equalization circuit 44, there is also an advantage that an effect can be obtained only by adding a simple circuit to the existing equalization circuit 44 as compared with a case where the size of the equalization circuit 44 is increased.

According to the energy storage apparatus 2, the energy storage apparatus 2 is used for the UPS 1. When the energy storage apparatus 2 is used for the UPS 1, deterioration of the battery cell 16 can be suppressed during non-power failure, so that there is a high possibility that original performance can be exhibited during power failure.

### Embodiment 2

Embodiment 2 is a modification example of Embodiment 1. An energy storage apparatus according to Embodiment 2 does not include a discharge circuit, and a battery cell 16 is discharged using a circuit breaker 43.

Specifically, the circuit breaker 43 according to Embodiment 2 is a latch relay, and includes a movable iron core and an excitation coil that drives the movable iron core. In the discharge processing, a BMU 46 according to Embodiment 2 applies a current for closing the latch relay to the latch relay that has already been closed. This current is supplied from the battery cell 16. As a result, the battery cell 16 is discharged by the excitation coil.

According to the energy storage apparatus according to Embodiment 2, since the battery cell 16 is discharged by the circuit breaker 43, the discharge processing can be performed without newly adding hardware for discharging the battery cell 16.

In this case, although the latch relay has been described as an example of the circuit breaker 43, the circuit breaker 43 may be a normally closed relay, a normally open relay, or an FET. However, in order to flow a current for closing the circuit breaker 43 in a state in which the circuit breaker 43 is closed, a latch relay or a normally closed relay is more preferable.

In this case, the case where the current for closing the latch relay is applied when the latch relay is closed has been described as an example. However, a current for opening the latch relay may be applied when the latch relay is closed, the current for closing the latch relay may be applied when the latch relay is opened, or the current for opening the latch relay may be applied when the latch relay is opened.

### OTHER EMBODIMENTS

The energy storage apparatus of the present invention is not limited to the above embodiments, and various modifications may be made without departing from the gist of the present invention. For example, a configuration according to an embodiment can additionally be provided with a configuration according to another embodiment, or a configuration according to an embodiment can partially be replaced with a configuration according to another embodiment or a well-known technique. Furthermore, a configuration according to an embodiment can be removed partially. In addition, a well-known technique can be added to a configuration according to an embodiment.

(1) In the above embodiment, the case where the battery cell 16 is discharged under the conditions shown in Table 1 in the discharge processing has been described as an example. However, the condition for discharging the battery cell 16 is not limited thereto, and can be appropriately determined.

(2) In the above embodiment, when the discharge current is less than a predetermined reference value (for example, 0.001 C), the state is determined as the state (in other words, non-use state) in which the voltage of the battery cell 16 does not substantially change. Alternatively or in addition, a switch that manually turns on and off the circuit breaker 43 connected in series with an assembled battery 51 may be provided, and when the circuit breaker 43 is turned off, it may be determined that the state is the non-use state.

(3) In the above embodiment, the case where the separator 20 is configured separately from the positive electrode P and the negative electrode N has been described as an example; however, the separator 20 is not limited thereto. For example, the separator 20 may be an insulating coating layer or the like integrated with the positive and negative electrodes. The battery cell 16 having the insulating coating layer or the like integrated with the positive and negative electrodes may be referred to as a separator less. Since the insulating coating layer and the like correspond to a separator, the battery cell 16 referred to as the separator less is also included in the energy storage device in which the positive electrode P and the negative electrode N are immersed in the nonaqueous electrolyte solution 18 in a state of being partitioned by the separator.

(4) In the above embodiment, the case where the BMU 46 starts the discharge processing by determining that the voltage of the battery cell 16 does not substantially change when the value of the discharge current of the battery cell 16 becomes less than the predetermined reference value, and ends the discharge processing when the discharge current larger than the preset current value is measured has been described as an example.

On the other hand, when the change amount per unit time of the voltage of the battery cell 16 measured by the voltage sensor 42 becomes equal to or less than the predetermined reference value, it is determined that the voltage of the battery cell 16 does not substantially change, the discharge processing may be started, and when the change amount per unit time becomes larger than the predetermined reference value, the discharge processing may be ended.

Alternatively, when the change amount per unit time of the SOC becomes equal to or less than the predetermined reference value, it is determined that the voltage of the battery cell 16 does not substantially change, the discharge processing may be started, and when the change amount per unit time of the SOC becomes larger than the predetermined reference value, the discharge processing may be ended.

(5) In the above embodiment, when the battery cell 16 is discharged in the discharge processing, the amount of electricity discharged is charged by float charge. Since float charge is not performed under the control of the BMU 46, the BMU 46 is not involved in this charge. On the other hand, the UPS 1 may include a charger that operates under the control of the BMU 46, and in the deterioration suppression processing, after the battery cell 16 is discharged, the BMU 46 may control the charger to charge the battery cell 16. With such a configuration, it is possible to reduce the possibility that the battery cell 16 is not sufficiently charged when the battery cell 16 is used.

(6) In the above embodiment, the case where the discharge circuit 45 is provided separately from the equalization circuit 44, and the battery cell 16 is discharged using the discharge circuit 45 in the discharge processing has been described as an example. On the other hand, the battery cell 16 may be discharged using both the discharge resistor 45A of the discharge circuit 45 and the discharge resistor 44A of the equalization circuit 44.

(7) In the above embodiment, the case where the discharge circuit 45 is provided separately from the equalization circuit 44, and the battery cell 16 is discharged using the discharge circuit 45 in the discharge processing has been described as an example. On the other hand, the discharge circuit 45 may not be provided, and the battery cell 16 may be discharged using the discharge resistor 44A of the equalization circuit 44. In general, since the energy storage apparatus 2 includes the equalization circuit 44, when the battery cell 16 is discharged by the equalization circuit 44, the configuration of the battery cell 16 can be simplified as compared with the case where a discharge circuit is provided separately from equalization circuit 44.

(8) In the above embodiment, the case where the discharge processing is started when it is detected that the voltage does not substantially change has been described as an example. On the other hand, the battery cell 16 may be discharged when the state in which the voltage does not substantially change continues for a predetermined time or longer. When the time during which the state in which the voltage of the battery cell 16 does not substantially change continues is short (in other words, when the time during which the battery cell 16 is left is short), the battery cell 16 hardly deteriorates. When the battery cell 16 is discharged when the state in which the voltage does not substantially change continues for the predetermined time or longer, discharge with a small effect can be suppressed.

(9) In the above embodiment, the case where the discharge processing is started when it is detected that the voltage does not substantially change regardless of the level of the voltage of the battery cell 16 has been described as an example. On the other hand, the discharge processing may be executed when the voltage does not substantially change and the voltage or the SOC of the battery cell 16 is a predetermined value or more. When the voltage or the SOC is low, it is difficult to generate the polymer 100. When the voltage or the SOC is less than the predetermined value, discharge with a small effect can be suppressed by not executing the discharge processing.

(10) In the above embodiment, the ternary lithium ion battery has been described as an example of the energy storage device. However, the lithium ion battery is not limited to the ternary system, and may be, for example, an iron-based lithium ion battery.

(11) In the above embodiment, although the case where the resistance value of the discharge resistor 45A is larger than the resistance value of the discharge resistor 44A of the equalization circuit 44 has been described as an example, the resistance value of the discharge resistor 45A can be appropriately selected. For example, the resistance value of the discharge resistor 45A may be equal to or smaller than the resistance value of the discharge resistor 44A of the equalization circuit 44.

(12) In the above embodiment, although the energy storage apparatus 2 used for the UPS 1 has been described as an example, the application of the energy storage apparatus 2 is not limited thereto. For example, the energy storage apparatus 2 may be mounted on a vehicle such as an automobile or a motorcycle to supply electric power to a starter or auxiliary equipment. The energy storage apparatus 2 may be for a moving body that is mounted on a forklift or an automatic guided vehicle (AGV) traveling by an electric motor and supplies electric power to the electric motor. The energy storage apparatus 2 may be used in an energy storage system that stores electric power generated by solar power generation. The energy storage apparatus 2 may be used in an energy storage system for performing the peak shift operation or the peak cut operation.

When the energy storage apparatus 2 is used for the energy storage apparatus mounted on the vehicle such as an automobile or a motorcycle, deterioration of the battery cell 16 can be suppressed during storage in a store or the like, so that there is a high possibility that the original performance can be exhibited when the energy storage apparatus 2 is mounted on the vehicle. The same applies to the case of using the energy storage apparatus 2 for a moving body such as a forklift.

When the energy storage apparatus 2 is used for the energy storage system, deterioration of the battery cell 16 can be suppressed during leaving until the energy storage system is operated, so that there is a high possibility that the original performance can be exhibited when the power system is operated.

Even when the energy storage apparatus 2 is used other than the UPS 1, the energy storage apparatus 2 may include a mechanism for turning on and off electrical connection between the energy storage apparatus 2 and the electric load, and when the electrical connection between the energy storage apparatus 2 and the electric load is turned off, the state may be determined as the state (in other words, non-use state) in which the voltage of the battery cell 16 does not substantially change.

(13) In the above embodiment, although the battery cell 16 which is a nonaqueous electrolyte secondary battery that can be charged and discharged has been described as an example of the energy storage device, the type, shape, size, capacity, and the like of the energy storage device are arbitrary. The present invention can also be applied to capacitors such as various secondary batteries, electric double layer capacitors, and lithium ion capacitors.

(14) In the above embodiment, although the battery cell 16 is charged during the charge period after the discharge period, the battery cell 16 doesn't have to be charged. That is, the discharge period and a charge-discharge pause period during which charge and discharge are not performed may be alternately repeated. A length of the charge-discharge pause period is the same as a length of the charge period. For example, when the energy storage apparatus 2 is stored as inventory at a store, the battery cell 16 is discharged during the discharge period. However, since the battery cell 16 is not charged after the discharge period, the discharge period and the charge-discharge pause period are alternately repeated.

### EXAMPLE

Hereinafter, the present invention will be described more specifically with reference to Examples. The present invention is not limited to the following examples.

### Example 1

(Preparation of Positive Electrode)

A positive composite paste, containing LiNi_{0.5}Co_{0.2}Mn_{0.3}O₂ as the positive active material, polyvinylidene fluoride (PVDF) as a binder, and acetylene black as a conductive agent and using n-methylpyrrolidone (NMP) as a dispersion medium, was prepared. A mass ratio of the positive active material, the binder, and the conductive agent was 93:3:4. The positive composite paste was applied to a surface of an aluminum foil as a positive electrode substrate, and a composite layer was compressed to a predetermined density and then dried to form a positive active material layer, thereby obtaining a positive electrode.

(Production of Negative Electrode)

A negative composite paste, containing graphite as a negative active material, styrene-butadiene rubber (SBR) as a binder, and carboxymethyl cellulose (CMC) as a thickener and using water as a dispersion medium, was prepared. Amass ratio of the negative active material, the binder, and the thickener was 98:1:1. The negative composite paste was applied to a surface of a copper foil as a negative electrode substrate, and a composite layer was compressed to a predetermined density and then dried to form a negative active material layer, thereby obtaining a negative electrode.

(Preparation of Separator)

As the separator, a separator including a substrate layer and a heat resistant layer was used. The substrate layer was a polyethylene microporous film having a thickness of 20 μm, and the heat resistant layer contained aluminosilicate particles. The porosity of the separator was 50%.

(Provision of Nonaqueous Electrolyte Solution)

Lithium hexafluorophosphate (LiPF₆) as an electrolyte salt was mixed with a nonaqueous solvent obtained by mixing ethylene carbonate, propylene carbonate, and ethyl methyl carbonate at a volume ratio of 20:10:70 so as to have a content of 1.0 mol/dm³, thereby preparing a nonaqueous electrolyte.

(Production of Energy Storage Device)

The positive electrode, the negative electrode, and the separator obtained in the above procedure were stacked and wound. Thereafter, a positive active material layer-non-formed region of the positive electrode and the negative active material layer-non-formed region of the negative electrode were welded to the positive electrode lead and the negative electrode lead, respectively, and sealed in an aluminum container, the container and a lid plate were welded, and then the nonaqueous electrolyte obtained above was injected to seal the container. In this way, an energy storage device of Example 1 was produced.

(Electrochemical Measurement)

The obtained energy storage device was subjected to electrochemical measurement according to the following procedure.

(Measurement of Initial Discharge Capacity)

The produced energy storage device was charged to 4.35 V at a charge current of 900 mA in a thermostatic bath at 25° C., further charged at a constant voltage of 4.35 V for 3 hours in total, and then subjected to constant current discharge to 2.75 V at a discharge current of 900 mA to measure an initial discharge capacity.

(Measurement of Direct Current Resistance (DCR) after Initial Charge and Discharge)

The energy storage device after measurement of the initial discharge capacity was charged to 3.73 V at a charge current of 900 mA in a thermostatic bath at 25° C., and further charged at a constant voltage of 3.73 V for 3 hours in total to set the SOC to 50%. When each energy storage device whose SOC was adjusted to 50% was discharged at discharge currents of 180 mA, 450 mA, and 900 mA, the voltage 10 seconds after the start of discharge was measured. Using these voltage measurement values, DCR after initial charge and discharge at 25° C. was calculated.

Next, the energy storage device was left in an environment of −10° C. for 5 hours, and then the voltage 10 seconds after the start of discharge was measured when each energy storage device whose SOC was adjusted to 50% was discharged at discharge currents of 90 mA, 180 mA, and 270 mA. Using these voltage measurement values, DCR after initial charge and discharge at −10° C. was calculated.

(Leaving Test)

The energy storage device whose initial discharge capacity and DCR after the initial charge and discharge were measured was left at 4.35 V for 60 days in a thermostatic bath at 60° C.

At this time, the discharge period for performing discharge and the charge period for performing charge were repeated under each of the conditions 1 to 4 shown in Table 2 below. For example, in the discharge period in the condition 2, discharge was always performed while alternately changing the intensity of the current over 4 minutes (pulse discharge time), discharge was not performed over 6 minutes (discharge pause time), and these discharge operations were repeated. When discharge was always performed while alternately changing the intensity of the current, flowing of a discharge pulse 1 for 0.5 milliseconds at a discharge rate of 1 CmA and flowing of a discharge pulse 2 for 88.5 milliseconds at a discharge rate of 0.01 CmA were repeated. In the charge period in the condition 2, the charge current was allowed to flow only for 2 minutes at a discharge rate of 0.03 CmA, and then charge was paused for 8 minutes.

Under any condition, the discharge period and the charge period were switched when the SOC of the energy storage device fluctuated by 0.11%.

TABLE 2

| | Discharge period | | | | | | Charge period | | | |
|---|---|---|---|---|---|---|---|---|---|---|
| | Discharge pulse 1 | | Discharge pulse 2 | | | | Magnitude | | | |
| | (main pulse) | | (weak pulse) | | Pulse | Discharge | of | | Charge | |
| | | Discharge | | Discharge | discharge | pause | charge | Charge | pause | Fluctuation |
| | Magnitude | time | Magnitude | time | time | time | current | time | time | SOC |
| | [CmA] | [msec] | [CmA] | [msec] | [min] | [min] | [CmA]] | [min] | [min] | [%] |
| Condition 1 | No charge | | | | | | | | | |
| Condition 2 | 1 | 0.5 | 0.01 | 88.5 | 4.0 | 6.0 | 0.03 | 2.0 | 8.0 | 0.11 |
| Condition 3 | 0.1 | 500 | 0.01 | 300 | 1.0 | 9.0 | 0.03 | 2.0 | 8.0 | 0.11 |
| Condition 4 | 0.1 | 40000 | — | — | 0.67 | 9.33 | 0.03 | 2.0 | 8.0 | 0.11 |

The discharge capacity, DCR at 25° C., and DCR at −10° C. were measured for the energy storage device at the time when 30 days passed and the energy storage device at the time when 60 days passed in the leaving test. The measurement procedure was performed similarly to the measurement of the initial discharge capacity and DCR after the initial charge and discharge.

The discharge capacity after the lapse of 30 days and after the lapse of 60 days was divided by the initial discharge capacity to calculate the capacity retention ratio. DCR after the lapse of 30 days and after the lapse of 60 days was divided by DCR after the initial charge and discharge to calculate a DCR change rate.

### Example 2

An energy storage device of Example 2 was produced similarly to Example 1 except that as a nonaqueous electrolyte solution, a solution obtained by dissolving LiPF₆ in a solvent in which FEC, PC, and EMC were mixed at a volume ratio of 10:10:40:40 so that the content was 1.2 mol/dm³ was used. The obtained energy storage device was subjected to electrochemical measurement under the same conditions as in Example 1, and the capacity retention ratio, the DCR change rate at 25° C., and the DCR change rate at −10° C. were calculated.

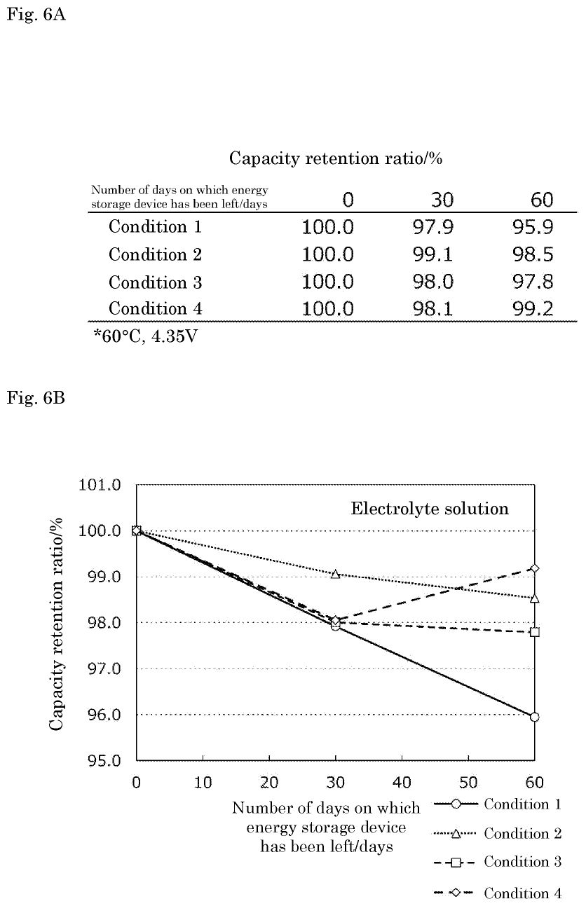

Experimental results are shown in FIGS. 6A and 6B to FIGS. 11A and 11B.

With reference to FIGS. 6A and 6B, the experimental result of the capacity retention ratio of Example 1 will be described. As shown in FIGS. 6A and 6B, the capacity retention ratio at the time when 60 days passed was 95.9% under the condition 1, whereas the capacity retention ratios were 98.5%, 97.8%, and 99.2% under the conditions 2 to 4. Thus, when the energy storage device is discharged when the voltage of the energy storage device does not substantially change (conditions 2 to 4), as compared with the case where the energy storage device is not discharged (condition 1), a decrease in the capacity retention ratio is suppressed at the time when 60 days passed.

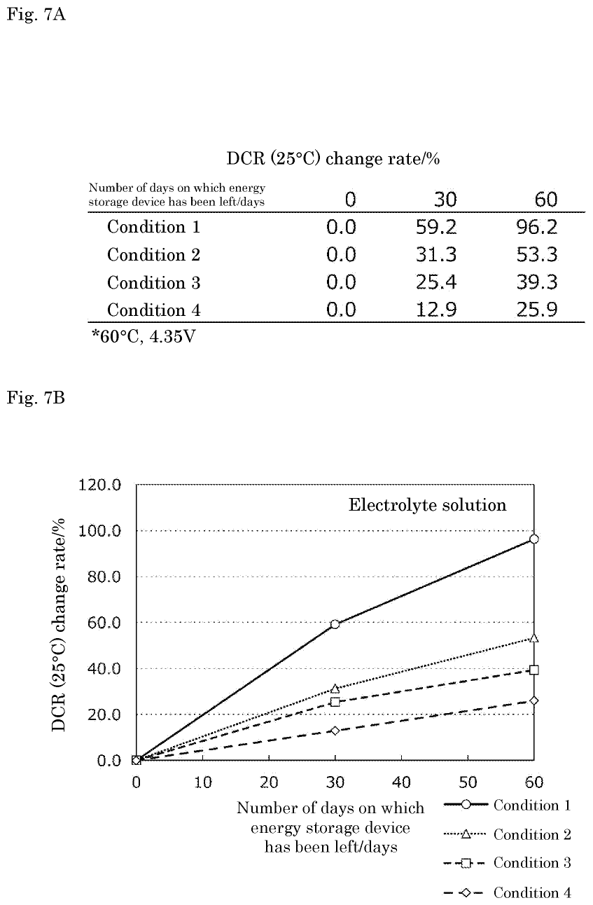

With reference to FIGS. 7A and 7B, the experimental results of the DCR change rate (ambient temperature: 25° C.) of Example 1 will be described. As shown in FIGS. 7A and 7B, the DCR change rate at the time when 60 days passed was 96.2% under the condition 1, whereas the DCR change rates were 53.3%, 39.3%, and 25.9% under the conditions 2 to 4. Thus, when the energy storage device is discharged when the voltage of the energy storage device does not substantially change (conditions 2 to 4), as compared with the case where the energy storage device is not discharged (condition 1), the DCR change rate is suppressed at the time when 60 days passed.

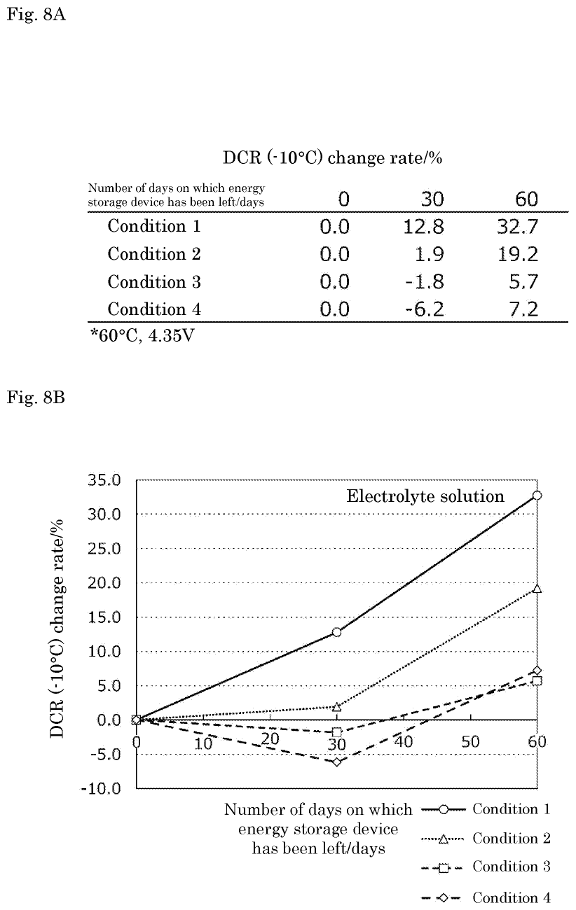

With reference to FIGS. 8A and 8B, the experimental results of the DCR change rate (ambient temperature: −10° C.) of Example 1 will be described. As shown in FIGS. 8A and 8B, the DCR change rate at the time when 60 days passed was 32.7% under the condition 1, whereas the DCR change rates were 19.2%, 5.7%, and 7.2% under the conditions 2 to 4. Thus, when the energy storage device is discharged when the voltage of the energy storage device does not substantially change (conditions 2 to 4), as compared with the case where the energy storage device is not discharged (condition 1), the DCR change rate is suppressed at the time when 60 days passed.

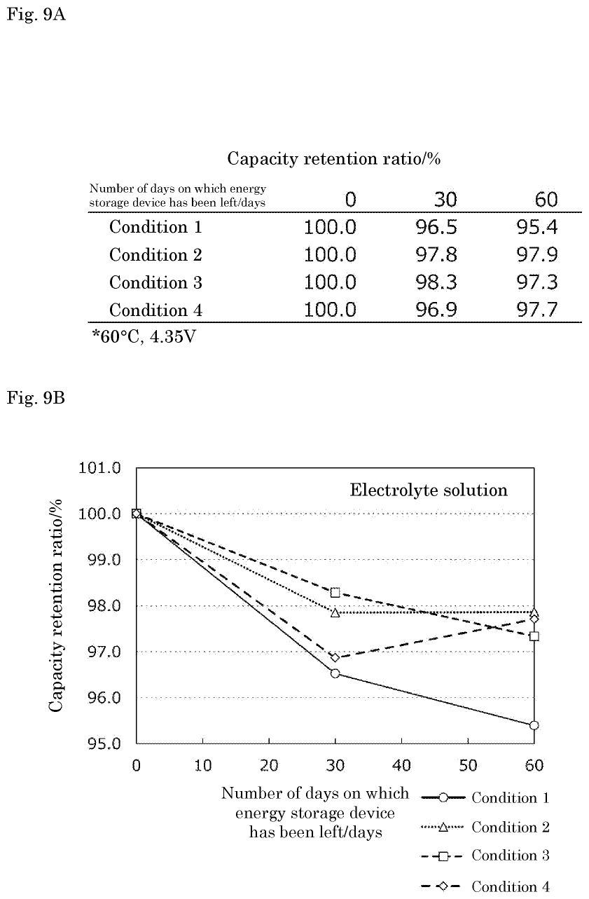

With reference to FIGS. 9A and 9B, the experimental result of the capacity retention ratio of Example 2 will be described. As shown in FIGS. 9A and 9B, the capacity retention ratio at the time when 60 days passed was 95.4% under the condition 1, whereas the capacity retention ratios were 97.9%, 97.3%, and 97.7% under the conditions 2 to 4. Thus, when the energy storage device is discharged when the voltage of the energy storage device does not substantially change (conditions 2 to 4), as compared with the case where the energy storage device is not discharged (condition 1), a decrease in the capacity retention ratio is suppressed at the time when 60 days passed.

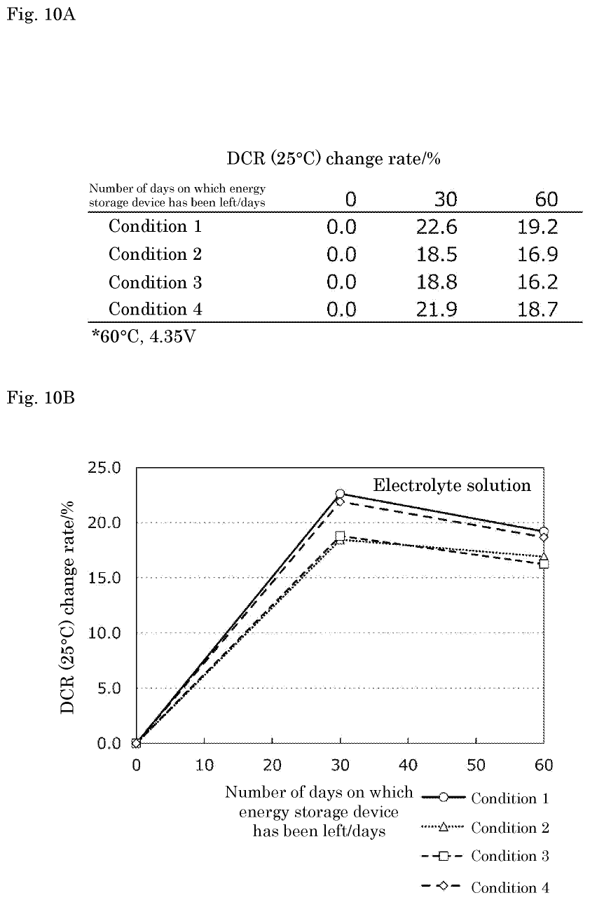

With reference to FIGS. 10A and 10B, the experimental results of the DCR change rate (ambient temperature: 25° C.) of Example 2 will be described. As shown in FIGS. 10A and 10B, the DCR change rate at the time when 60 days passed was 19.2% under the condition 1, whereas the DCR change rates were 16.9%, 16.2%, and 18.7% under the conditions 2 to 4. Thus, when the energy storage device is discharged when the voltage of the energy storage device does not substantially change (conditions 2 to 4), as compared with the case where the energy storage device is not discharged (condition 1), the DCR change rate is suppressed at the time when 60 days passed.

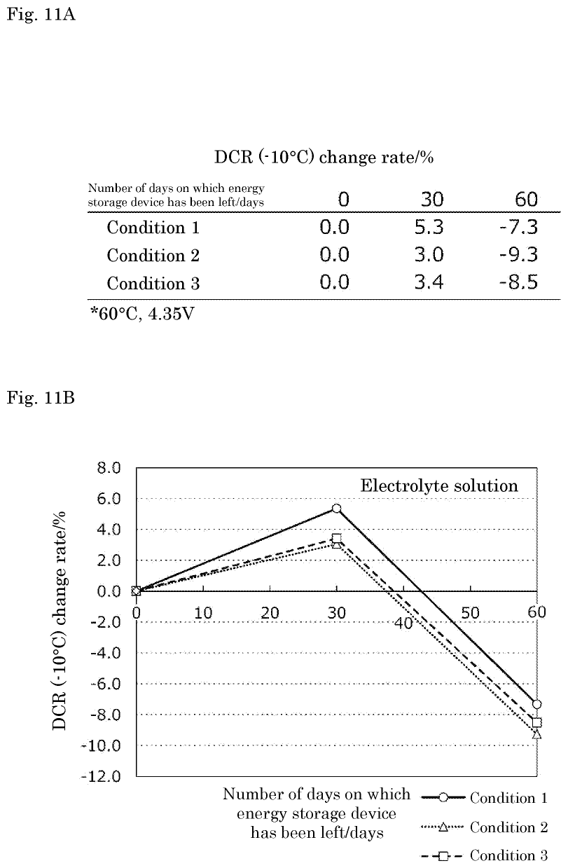

With reference to FIGS. 11A and 11B, the experimental results of the DCR change rate (ambient temperature: −10° C.) of Example 2 will be described. As shown in FIGS. 11A and 11B, the DCR change rate at the time when 60 days passed was −7.3% under the condition 1, whereas the DCR change rates were −9.3% and −8.5% under the conditions 2 and 3. Thus, when the energy storage device is discharged when the voltage of the energy storage device does not substantially change (conditions 2 and 3), as compared with the case where the energy storage device is not discharged (condition 1), the DCR change rate is suppressed at the time when 60 days passed.

### Example 3

(Preparation of Positive Electrode)

A positive composite paste, containing LiFePO₄ as the positive active material, polyvinylidene fluoride (PVDF) as a binder, and acetylene black as a conductive agent and using n-methylpyrrolidone (NMP) as a dispersion medium, was prepared. The mass ratio of the positive active material, the binder, and the conductive agent was 90:5:5. The positive composite paste was applied to a surface of an aluminum foil as a positive electrode substrate, and a positive composite was compressed to a predetermined density and a predetermined thickness and then dried to form a positive active material layer, thereby obtaining a positive electrode.

(Production of Negative Electrode)

A negative composite paste, containing graphite as a negative active material, styrene-butadiene rubber (SBR) as a binder, and carboxymethyl cellulose (CMC) as a thickener and using water as a dispersion medium, was prepared. The mass ratio of the negative active material, the binder, and the thickener was 97:2:1. The negative composite paste was applied to a surface of a copper foil as a negative electrode substrate, and a negative composite was compressed to a predetermined density and a predetermined thickness and then dried to form a negative active material layer, thereby obtaining a negative electrode.

(Provision of Nonaqueous Electrolyte)

LiPF₆ was dissolved in a solvent in which EC, DMC, and EMC were mixed at a volume ratio of 20:35:45 so that the content was 0.9 mol/dm³.

(Preparation of Separator)

As the separator, a polyethylene microporous film having a thickness of 16 μm was used. The porosity of the separator was 44%.

(Production of Energy Storage Device)

An energy storage device of Example 3 was produced similarly to Example 1 except that the positive electrode, the negative electrode, the separator, and the nonaqueous electrolyte obtained in the above procedure were used.

The obtained energy storage device was subjected to electrochemical measurement according to the following procedure.

(Measurement of Initial Discharge Capacity)

The produced energy storage device was charged to 3.50 V at a charge current of 550 mA in a thermostatic bath at 25° C., further charged at a constant voltage of 3.50 V for 3 hours in total, and then subjected to constant current discharge to 2.00 V at a discharge current of 550 mA to measure the initial discharge capacity.

(Measurement of Direct Current Resistance (DCR) after Initial Charge and Discharge)

The energy storage device after measurement of the initial discharge capacity was subjected to constant current discharge to 2.00 V at a discharge current of 110 mA in a thermostatic bath at 25° C., and then charged for 30 minutes at a current value with which the initial discharge capacity can be charged in an hour to set the SOC to 50%. The energy storage device whose SOC was adjusted to 50% was left in an environment of −10° C. for 5 hours, and then the voltage 10 seconds after the start of discharge was measured when each energy storage device whose SOC was adjusted to 50% was discharged at discharge currents of 55 mA, 110 mA, and 165 mA. Using these voltage measurement values, DCR after initial charge and discharge at −10° C. was calculated.

(Leaving Test)

The energy storage device whose initial discharge capacity and DCR after the initial charge and discharge were measured was left at 3.50 V for 60 days in a thermostatic bath at 60° C.

At this time, the discharge period for performing discharge and the charge period for performing charge were repeated under the condition shown in Table 3 below.

TABLE 3

| | Discharge period | | | | | | Charge period | | | |
|---|---|---|---|---|---|---|---|---|---|---|
| | Discharge pulse 1 | | Discharge pulse 2 | | | | Magnitude | | | |
| | (main pulse) | | (weak pulse) | | Pulse | Discharge | of | | Charge | |
| | | Discharge | | Discharge | discharge | pause | charge | Charge | pause | Fluctuation |
| | Magnitude | time | Magnitude | time | time | time | current | time | time | SOC |
| | [CmA] | [msec] | [CmA] | [msec] | [min] | [min] | [CmA]] | [min] | [min] | [%] |
| Condition 5 | 0.1 | 0.5 | 0.02 | 4 | 4.0 | 6.0 | 0.05 | 2.0 | 8.0 | 0.111 |
| Condition 6 | 1 | 0.5 | 0.02 | 53.5 | 4.0 | 6.0 | 0.05 | 2.0 | 8.0 | 0.111 |
| Condition 7 | 0.1 | 5 | 0.02 | 40 | 4.0 | 6.0 | 0.05 | 2.0 | 8.0 | 0.111 |
| Condition 8 | 0.1 | 517.8 | 0.02 | 650 | 2.0 | 8.0 | 0.05 | 2.0 | 8.0 | 0.111 |
| Condition 9 | 0.5 | 461.2 | 0.02 | 650 | 1.0 | 9.0 | 0.05 | 4.0 | 6.0 | 0.222 |
| Condition 10 | 1 | 482.2 | 0.02 | 650 | 1.0 | 9.0 | 0.05 | 8.0 | 2.0 | 0.444 |
| Condition 11 | 0.1 | 519.1 | 0.02 | 650 | 8.0 | 2.0 | 0.05 | 8.0 | 2.0 | 0.444 |
| Condition 12 | 0.1 | 65000.0 | — | — | 1.1 | 8.9 | 0.1 | 2.0 | 8.0 | 0.110 |

| | |
|---|---|
| Condition 1 | No charge |

The discharge capacity and DCR at −10° C. were measured for the energy storage device at the time when 60 days passed and the energy storage device at the time when 90 days passed in the leaving test. The measurement procedure was performed similarly to the measurement of the initial discharge capacity and DCR after the initial charge and discharge. DCR after the lapse of 60 days and after the lapse of 90 days was divided by DCR after the initial charge and discharge to calculate the DCR change rate.

Similarly to Example 1 described above, also in Example 3, the current was continuously caused to flow constantly while changing the intensity of the current during the pulse discharge time. For example, in condition 5, flowing of the discharge pulse 1 (main pulse) only for 0.5 milliseconds at a discharge rate of 0.1 CmA during the pulse discharge time and flowing of the discharge pulse 2 (weak pulse) only for 4 milliseconds at a discharge rate of 0.02 CmA are alternately repeated for 4 minutes.

In Example 3, a charge mode during the charge period varies depending on the conditions. For example, in the charge period in the condition 5, the charge current was allowed to flow for 2 minutes at a charge rate of 0.05 CmA, and then charge was paused for 8 minutes. In the charge period in the condition 9, the charge current was allowed to flow for 4 minutes at a discharge rate of 0.05 CmA, and then charge was paused for 6 minutes.

In Example 3, fluctuation SOC [%] for switching between the discharge period and the charge period also varies depending on the conditions. For example, under the condition 5, the discharge period and the charge period were switched when SOC of the energy storage device fluctuated by 0.111%. Under condition 9, the discharge period and the charge period were switched when SOC fluctuated by 0.222%.

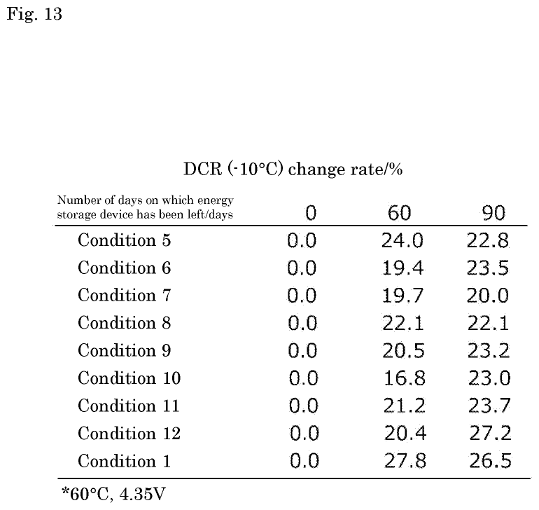

Experimental results are shown in FIG. 13. As shown in FIG. 13, the DCR change rate at the time when 60 days passed was 27.8% under the condition 1 (no charge and discharge), whereas the DCR change rates were 24.0%, 19.4%, 19.7%, 22.1%, 20.5%, 16.8%, 21.2%, and 20.4% under the conditions 5 to 12.

The DCR change rate at the time when 90 days passed was 26.5% under the condition 1, whereas the DCR change rates were 22.8%, 23.5%, 20.0%, 22.1%, 23.2%, 23.0%, 23.7%, and 27.2% under the conditions 5 to 12.

Under the conditions 5 to 11, the DCR change rate at the time when 60 days passed and the DCR change rate at the time when 90 days passed were both suppressed as compared with the condition 1 (no charge and discharge). Thus, under the conditions 5 to 11, an effect of suppressing the DCR change rate was exhibited even when the energy storage device was left for a long period of time such as 90 days.

In the condition 12, the DCR change rate at the time when 90 days passed was not significantly different from the condition 1; however, the DCR change rate at the time when 60 days passed was suppressed as compared with the condition 1. From this, even in the condition 12, a remarkable effect in suppressing the DCR change rate was observed as compared with the condition 1 until 60 days elapsed.

As shown in Table 3 described above, in the conditions 5 to 11, the discharge time of the discharge pulse 1 is less than 1 second, and in the condition 12, the discharge time of the discharge pulse 1 is 1 second or more (specifically, 65 seconds). In the condition 12, the DCR change rate at the time when 90 days passed is not significantly different from the condition 1, and therefore, in order to reliably achieve the effect of suppressing the DCR change rate even when the energy storage device is left for a long period of time, the discharge time of the discharge pulse 1 is preferably less than 1 second, and more preferably less than 520 milliseconds.

As shown in Table 3 described above, in the conditions 5 to 12, the magnitude of the discharge pulse is any of 0.1 CmA, 0.5 CmA, and 1 CmA. In any of the conditions 5 to 12, since the DCR change rate at the time when 60 days passed is suppressed as compared with the condition 1, the lower limit value of the magnitude of the discharge pulse is preferably 0.1 CmA or more. The lower limit value of the magnitude of the discharge pulse may be 0.1 CmA, 0.5 CmA, or 1 CmA.

As shown in Table 3 described above, in the conditions 5 to 11, the magnitude of the charge pulse during the charge period is 0.05 CmA, and in the condition 12, the magnitude of the charge pulse is 0.1 CmA. In the condition 12, although the DCR change rate at the time when 90 days passed is not significantly different from the condition 1, since the DCR change rate at the time when 60 days passed is suppressed as compared with the condition 1, the magnitude of the charge pulse during the charge period is preferably 0.1 CmA or less, and more preferably 0.05 CmA or less.

As is apparent from the above results, deterioration of the energy storage device can be suppressed by discharging the energy storage device when the voltage of the energy storage device does not substantially change. Although the reason why such an effect can be obtained is not clear, it is considered that the atmosphere in which the polymerization reaction tends to proceed is eliminated by discharge.

Although the present invention has been described in detail above, the embodiments described above are merely examples, and the invention disclosed herein includes various modifications and changes made to the specific examples illustrated above.

### DESCRIPTION OF REFERENCE SIGNS

2: energy storage apparatus
16: battery cell (example of energy storage device)
18: nonaqueous electrolyte solution
20: separator
40: CMU (example of management unit)
43: circuit breaker
44: equalization circuit
44A: discharge resistor (example of first discharge resistor)
45: discharge circuit (example of circuit other than main circuit)
45A: discharge resistor (example of second discharge resistor)
46: BMU (example of management unit)
60: main circuit
N: negative electrode
P: positive electrode

1. An energy storage apparatus comprising:
an energy storage device in which a positive electrode and a negative electrode are immersed in a nonaqueous electrolyte solution in a state of being partitioned by a separator; and
a management unit,
wherein the management unit executes detection processing of detecting a state in which a voltage of the energy storage device does not substantially change, and discharge processing of discharging the energy storage device in response to detection of the state in the detection processing.

2. The energy storage apparatus according to claim 1, wherein the state is a non-use state in which the energy storage apparatus is not used.

3. The energy storage apparatus according to claim 1, wherein the energy storage device is a lithium ion battery in which the positive electrode contains a ternary active material.

4. The energy storage apparatus according to claim 1, wherein in the discharge processing, the management unit intermittently discharges the energy storage device, or discharges the energy storage device while alternately changing an intensity of a current.

5. The energy storage apparatus according to claim 1, wherein the management unit causes a charger to charge the energy storage device after discharging the energy storage device in the discharge processing.

6. The energy storage apparatus according to claim 1, wherein the management unit discharges the energy storage device by a circuit other than a main circuit to which the energy storage device is connected in the discharge processing.

7. The energy storage apparatus according to claim 6, further comprising a circuit breaker connected in series with the energy storage device,
wherein in the discharge processing, the management unit causes a current for opening the circuit breaker or a current for closing the circuit breaker to flow from the energy storage device to the circuit breaker to discharge the energy storage device.

8. The energy storage apparatus according to claim 6, further comprising:
a plurality of the energy storage devices; and
an equalization circuit that has a discharge resistor and equalizes a voltage of each of the energy storage devices by discharging the energy storage device, having a relatively high voltage among the plurality of energy storage devices, with the discharge resistor,
wherein the management unit causes the equalization circuit to discharge the energy storage device in the discharge processing.

9. The energy storage apparatus according to claim 6, further comprising:
a plurality of the energy storage devices;
an equalization circuit that has a first discharge resistor and equalizes a voltage of each of the energy storage devices by discharging the energy storage device, having a relatively high voltage among the plurality of energy storage devices, with the first discharge resistor; and
a discharge circuit that has a second discharge resistor,
wherein the management unit causes the discharge circuit to discharge the energy storage device in the discharge processing.

10. The energy storage apparatus according to claim 1, wherein the management unit executes the discharge processing when the state in which the voltage of the energy storage device does not substantially change continues for a predetermined time or longer.

11. The energy storage apparatus according to claim 1, wherein the management unit executes the discharge processing when the state in which the voltage of the energy storage device does not substantially change is detected by the detection processing and when the voltage or a charge state of the energy storage device is a predetermined value or more.

12. The energy storage apparatus according to claim 1, being used in an uninterruptible power supply.

13. The energy storage apparatus according to claim 1, being mounted on a vehicle.

14. The energy storage apparatus according to claim 1, being used in an energy storage system.

15. A method of suppressing deterioration of an energy storage device in which a positive electrode and a negative electrode are immersed in a nonaqueous electrolyte solution in a state of being partitioned by a separator, the method comprising:
a detection step of detecting a state in which a voltage of the energy storage device does not substantially change; and
a discharge step of discharging the energy storage device in response to detection of the state in the detection step.
